(19) United States
(12) Patent Application Publication
(10) Pub. No.: US 2026/0104094 A1
(43) Pub. Date: Apr. 16, 2026

(54) SEALING MEMBER AND SEALING STRUCTURE

(71) Applicant: NOK CORPORATION, Tokyo (JP)

(72) Inventor: Yuta KIKUCHIYA, Kumamoto (JP)

(73) Assignee: NOK CORPORATION, Tokyo (JP)

(21) Appl. No.: 19/351,852

(22) Filed: Oct. 7, 2025

(30) Foreign Application Priority Data
Oct. 10, 2024 (JP) 2024-178250

(51) Int. Cl. F16J 15/3276; F15B 15/14

(52) U.S. Cl. CPC F16J 15/3276; F15B 15/1461

(57) ABSTRACT

A sealing member seals a space between a pin and a movable pin device. The movable pin device is aligned with a panel in an axial direction with a space between the movable pin device and the panel. The pin is through the panel and the movable pin device along an axis and is reciprocable in the axial direction. The sealing member includes a first annular portion including a first sealing flange to seal a space between the first sealing flange and the movable pin device, and a second annular portion to come in contact with the pin in a slidable manner. The first annular portion further includes a protruding portion located farther than the first sealing flange in the first direction to come in contact with the panel.

### BACKGROUND

### 1. Technical Field

The present invention relates to a sealing member and a sealing structure.

### 2. Description of the Background

A known sealing member seals a space between a penetrator reciprocable along an axis and a holder holding the penetrator (e.g., Patent Literature 1). The sealing member described in Patent Literature 1 is placed in a space between a cylinder (holder) and a rod (penetrator) sliding on each other in a hydraulic or pneumatic device. The sealing member is annular and received in a sealing groove on the cylinder. The sealing member includes an outer lip that comes in contact with the cylinder and an inner lip that comes in contact with the rod. The outer lip and the inner lip are connected together with a connecting portion that divides a high-pressure area and a low-pressure area and serves as an end face.

A known annular sealing member includes the outer lip, the inner lip, and the connecting portion, and has a shape different from the shape of the sealing member in Patent Literature 1 (e.g., Patent Literature 2). The sealing member described in Patent Literature 2 includes an inner cylindrical portion (inner lip), an outer cylindrical portion (outer lip), and an annular connecting portion (connecting portion). The inner cylindrical portion includes a gradually decreasing diameter portion with a diameter that decreases gradually in a first direction along an axis. The outer cylindrical portion includes a gradually increasing diameter portion with a diameter that increases gradually in the first direction. The annular connecting portion connects, to each other, the ends of the inner cylindrical portion and the outer cylindrical portion in a second direction opposite to the first direction. The outer cylindrical portion includes an elongated cylindrical portion extending, in the first direction, from the end of the gradually increasing diameter portion in the first direction. The elongated cylindrical portion has an outer diameter that decreases gradually in the first direction.

### CITATION LIST

### PATENT LITERATURE

Patent Literature 1: Japanese Unexamined Patent Application Publication No. 2019-148283

Patent Literature 2: Japanese Unexamined Patent Application Publication No. 2018-169016

### BRIEF SUMMARY

When the space between the penetrator and the holder is sealed with the annular sealing member including the outer lip, the inner lip, and the connecting portion, the sealing groove on the holder may be stepped and open to a portion opposite to the connecting portion. When the penetrator moves from the portion opposite to the connecting portion toward the connecting portion in this structure, the sealing member may move in response to the movement of the penetrator and cause the outer lip to slip out of the sealing groove. To prevent the outer lip from slipping out of the sealing groove, the outer lip may include the elongated cylindrical portion as described in Patent Literature 2 for the elongated cylindrical portion to come in contact with a structure located adjacent to the opening of the sealing groove and defining a space between the structure and the holder. The structure is separate from the sealing member, the penetrator, and the holder. The sealing member that allows the elongated cylindrical portion to come in contact with the structure may have various failures resulting from an axial component of an elastic force generated by such contact between the elongated cylindrical portion and the structure.

One or more aspects of the present disclosure are directed to a technique for reducing the likelihood of a first sealing flange slipping out of a second structure in response to a penetrator moving in a first direction.

An aspect of the present disclosure provides a sealing member for sealing a space between a penetrator and a second structure, the second structure being aligned with a first structure on an axis extending in an axial direction with a space between the second structure and the first structure, the penetrator being through the first structure and the second structure along the axis and being reciprocable in the axial direction, the sealing member comprising:

a first annular portion to come in contact with the second structure, the first annular portion including a first sealing flange to seal a space between the first sealing flange and the second structure;

a second annular portion to come in contact with the penetrator in a slidable manner; and

a connecting portion connecting ends of the first annular portion and the second annular portion, the ends being located in a direction opposite to a first direction from the second structure to the first structure parallel to the axial direction,

wherein the first annular portion further includes a protruding portion located farther than the first sealing flange in the first direction to come in contact with the first structure.

Another aspect of the present disclosure provides a sealing member, comprising:

a first annular portion located about an axis, the first annular portion including, at an end of the first annular portion in a first direction along the axis, a first sealing flange protruding radially outward;

a second annular portion spaced and radially inward from the first annular portion;

a connecting portion connecting ends of the first annular portion and the second annular portion, the ends being located in a direction opposite to the first direction; and

a protruding portion located farther than the first sealing flange in the first direction, the protruding portion having a first distance between a center of thickness of the protruding portion and the axis, the first distance increasing in the first direction.

The technique according to the above aspect of the present disclosure reduces the likelihood of the first sealing flange slipping out of the second structure in response to the penetrator moving in the first direction.

The technique according to the other aspect of the present disclosure reduces a component of an elastic force generated by contact between the protruding portion and the structure, which is spaced from the protruding portion in the first direction, in the axial direction.

### BRIEF DESCRIPTION OF DRAWINGS

FIG. 1 is a schematic sectional view of a lock pin structure in an embodiment.

FIG. 2 is a sectional view of a sealing structure according to the embodiment.

FIG. 3 is a sectional view of a sealing member according to the embodiment.

FIG. 4 is a perspective view of the sealing member according to the embodiment.

FIG. 5 is a sectional view of the sealing member according to the embodiment in a second structure.

FIG. 6 is a sectional view of a sealing member in a comparative example in the second structure.

FIG. 7 is a sectional view of the sealing member in the comparative example in the second structure.

FIG. 8 is a sectional view of a sealing member in a comparative example.

FIG. 9 is a sectional view of the sealing member in the comparative example in the second structure.

FIG. 10 is a perspective view of a sealing member according to another embodiment.

### DETAILED DESCRIPTION

One or more embodiments of the present disclosure will now be described with reference to the drawings. The drawings may not be drawn to scale, and some features may be exaggerated or omitted.

Hereafter, the axis of a sealing member is defined as the X-axis or the axis X. The direction from a first member toward a second member is defined as the negative X-direction. The direction from the second member toward the first member is defined as the positive X-direction. In the radial direction with respect to the axial direction, the direction away from the central axis is referred to as radially outward. In the radial direction with respect to the axial direction, the direction toward the central axis is referred to as radially inward.

A sealing member 40 according to an embodiment is used in a lock pin structure 10. The lock pin structure 10 is used in a charging system using a plug and an inlet for devices (not shown) such as electric vehicles. The sealing member according to one or more embodiments of the present disclosure may not be used in the lock pin structure used in the charging system using the plug and the inlet. The sealing member according to one or more embodiments of the present disclosure may be used in a lock pin structure used in a fuel supply system using a fuel nozzle and a fuel filler.

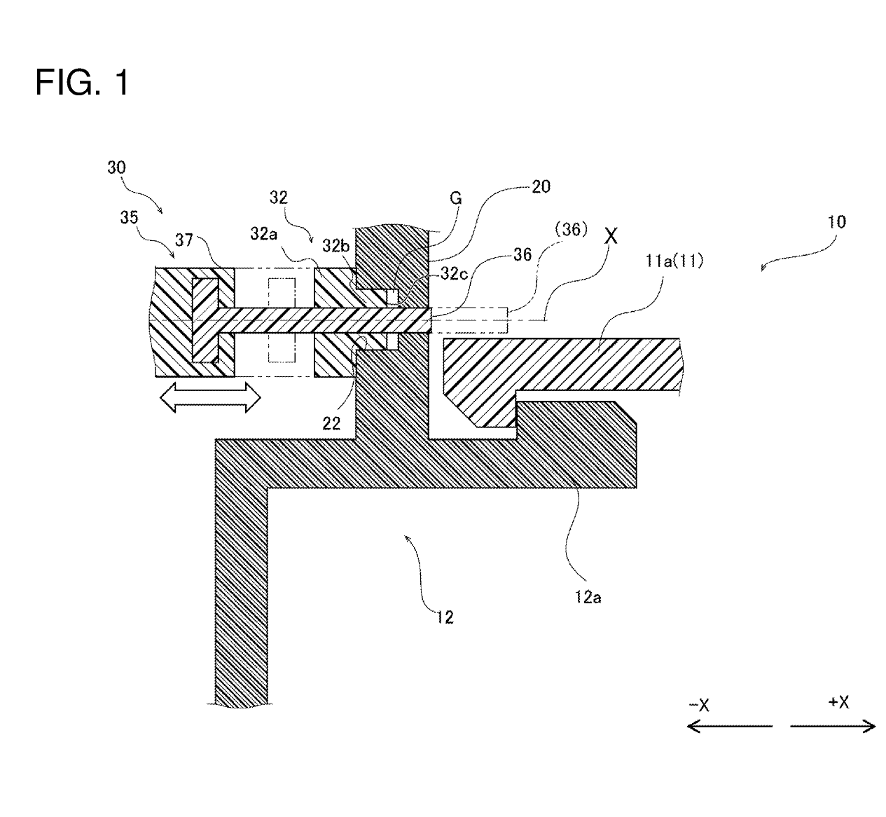

The lock pin structure 10 in the embodiment includes a plug 11, an inlet 12, and a movable pin device 30 as shown in FIG. 1.

The plug 11 is located in a charging gun (not shown) in a power supply (not shown) that can supply power to a device. The plug 11 is attachable to and detachable from the inlet 12. The plug 11 includes a latch 11a. The latch 11a engages with the inlet 12 when the plug 11 is attached to the inlet 12.

The inlet 12 is located in the device. The inlet 12 is recessed from a panel 20 of the device. The panel 20 is the exterior of the device. The inlet 12 is open to the outside of the device. The inlet 12 can receive the plug 11 inside. The inlet 12 includes a latch 12a. The latch 12a protrudes outward from the device with respect to the panel 20 of the device. When the inlet 12 receives the plug 11, the latch 12a engages with the latch 11a in the plug 11 as shown in FIG. 1.

The panel 20 includes a receiver 22. The receiver 22 is located on the inner surface of the panel 20. The inner surface of the panel 20 faces the inside of the device. The receiver 22 is recessed from the inner surface of the panel 20. The receiver 22 can receive the movable pin device 30. The panel 20 is an example of a first structure.

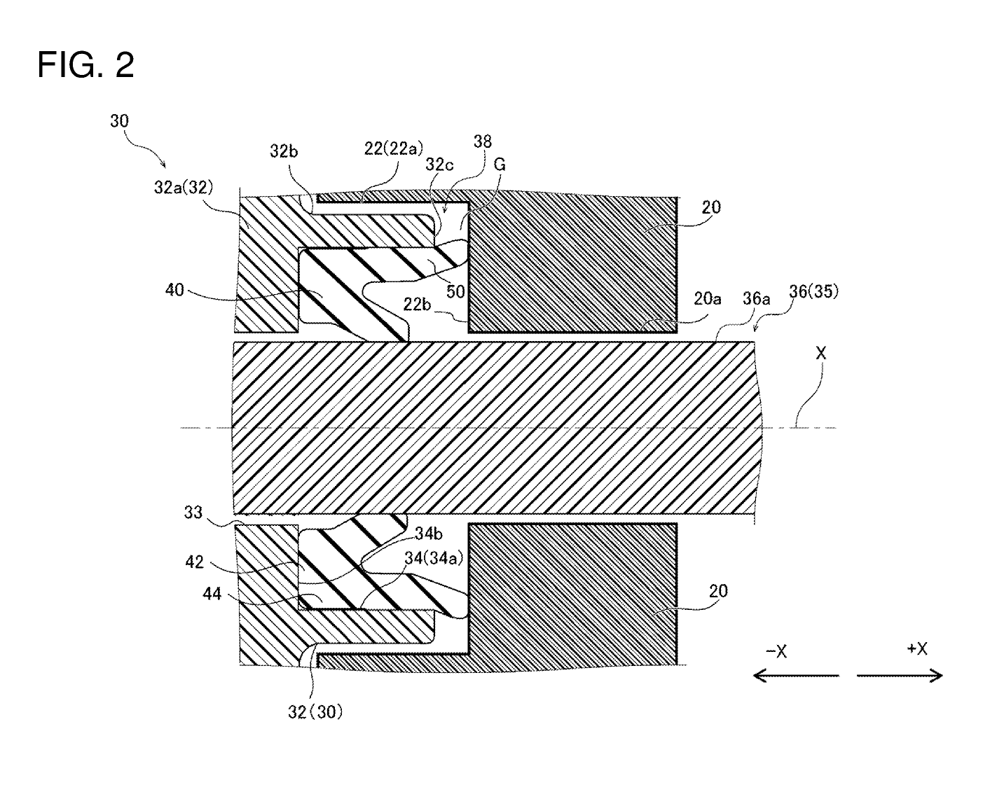

As shown in FIG. 2, the receiver 22 has a bottom 22b, a wall 22a, and a through-hole 20a. The bottom 22b is the bottom of the recessed receiver 22. The bottom 22b is in contact with a protruding portion 50 in the sealing member 40 (described later). The wall 22a extends from the inner surface of the panel 20 to the bottom 22b and surrounds the bottom 22b. The wall 22a is, for example, cylindrical and faces radially inward. The through-hole 20a extends through the panel 20 from the bottom 22b to the outer surface of the panel 20. The through-hole 20a extends in the X-direction. The through-hole 20a is, for example, cylindrical. The movable pin device 30 (described later) includes a pin 36 that can pass through the through-hole 20a. The through-hole 20a overlaps the axis X as viewed in the axial direction.

When the latch 11a engages with the latch 12a in response to the plug 11 being attached to the inlet 12, the movable pin device 30 locks the latch 11a to prevent the latch 11a from being disengaged from the latch 12a. In other words, in response to the latch 11a engaging with the latch 12a, the movable pin device 30 operates to maintain the engagement of the latch 11a with the latch 12a. As shown in FIG. 1, the movable pin device 30 is attached to the panel 20 with a space G defined between the movable pin device 30 and the bottom 22b of the receiver 22. In other words, the movable pin device 30 is aligned with the panel 20 on the axis X with the space G between the movable pin device 30 and the panel 20. The movable pin device 30 is an example of a second structure. The movable pin device 30 includes a holder 32, a movable unit 35, and the sealing member 40 (not shown in FIG. 1). As shown in FIG. 2, the holder 32, the movable unit 35, and the sealing member 40 form a sealing structure 38 in the movable pin device 30.

As shown in FIG. 1, the holder 32 covers the receiver 22 from inside the device. The holder 32 defines the space G between the holder 32 and the bottom 22b of the receiver 22. The holder 32 holds the pin 36 in a manner reciprocable through the through-hole 20a. As shown in FIG. 2, the holder 32 includes a body 32a, a fitting portion 32b, a step 34, and a hole 33.

As shown in FIG. 1, the body 32a is in contact with a portion of the panel 20 around the receiver 22. The body 32a may be connected to the panel 20 with a connecting member such as a bolt.

The fitting portion 32b protrudes from the body 32a toward the panel 20. The fitting portion 32b is placed inside the receiver 22. As shown in FIG. 2, the fitting portion 32b is fitted to the wall 22a of the receiver 22. The fitting portion 32b has an end face 32c. The end face 32c faces the bottom 22b of the receiver 22. The end face 32c defines the space G between the end face 32c and the bottom 22b.

As shown in FIG. 2, the step 34 is recessed from the end face 32c. The step 34 has a step surface 34b and a wall 34a. The step surface 34b is the bottom of the recessed step 34. The step surface 34b is in contact with a connecting portion 42 in the sealing member 40. The wall 34a extends from the end face 32c to the step surface 34b and surrounds the step surface 34b. The wall 34a is, for example, cylindrical and faces radially inward. The wall 34a is in contact with a first annular portion 44 in the sealing member 40.

The hole 33 extends through the holder 32 from the step surface 34b of the step 34 to the end of the body 32a in the negative X-direction. The hole 33 extends in the X-direction. The hole 33 is, for example, cylindrical. The hole 33 is coaxial with the through-hole 20a. The hole 33 holds the pin 36 in a slidable and reciprocable manner.

In response to the latch 11a in the plug 11 and the latch 12a in the inlet 12 engaging with each other, the movable unit 35 operates to maintain the engagement between the latch 11a and the latch 12a. As shown in FIG. 1, the movable unit 35 includes the pin 36 and an assembly 37.

As shown in FIG. 2, the pin 36 extends through the through-hole 20a in the panel 20 and the hole 33 in the holder 32. The pin 36 is an example of a penetrator. The pin 36 extends along the axis X. The pin 36 may have two longitudinal ends protruding outward from the holder 32. The pin 36 is, for example, cylindrical. The pin 36 is coaxial with the through-hole 20a and the hole 33. The pin 36 has a cylindrical surface 36a. The cylindrical surface 36a faces radially outward.

As shown in FIG. 1, the assembly 37 can allows the pin 36 to reciprocate between a first position and a second position on the axis X. The second position is in the positive X-direction from the first position. When the pin 36 is at the first position, the distal end of the pin 36 in the positive X-direction does not obstruct attachment and detachment of the plug 11 to and from the inlet 12. When the pin 36 is at the second position, the distal end of the pin 36 in the positive X-direction protrudes outward from the device beyond the panel 20 to hold the latch 11a in the plug 11 attached to the inlet 12 between the distal end of the pin 36 in the positive X-direction and the latch 12a. The pin 36 at the second position locks the plug 11 attached to the inlet 12. In this state, the plug 11 is locked.

The assembly 37 is connected to the end of the pin 36 in the negative X-direction. In response to the latch 11a in the plug 11 and the latch 12a in the inlet 12 engaging with each other, the assembly 37 moves the pin 36 from the first position to the second position. To release the plug 11 from being rocked, a user (not shown) performs a release operation on the pin 36 at the second position. The release operation is, for example, pushing the distal end in the positive X-direction of the pin 36, which is at the second position, toward a position in the negative X-direction. In response to the release operation, the assembly 37 operates to fix the pin 36 at the first position. In this state, the plug 11 is unlocked. The assembly 37 may include an actuator drivable by a motor. The release operation on the pin 36 may be performed remotely using an input device including, for example, a push button switch.

### Sealing Member 40

As shown in FIG. 2, the sealing member 40 is located between the step 34 and the pin 36. The sealing member 40 seals a space between the pin 36 and the holder 32. The sealing member 40 prevents foreign objects from entering a slide portion between the hole 33 and the pin 36 from outside the sealing member 40.

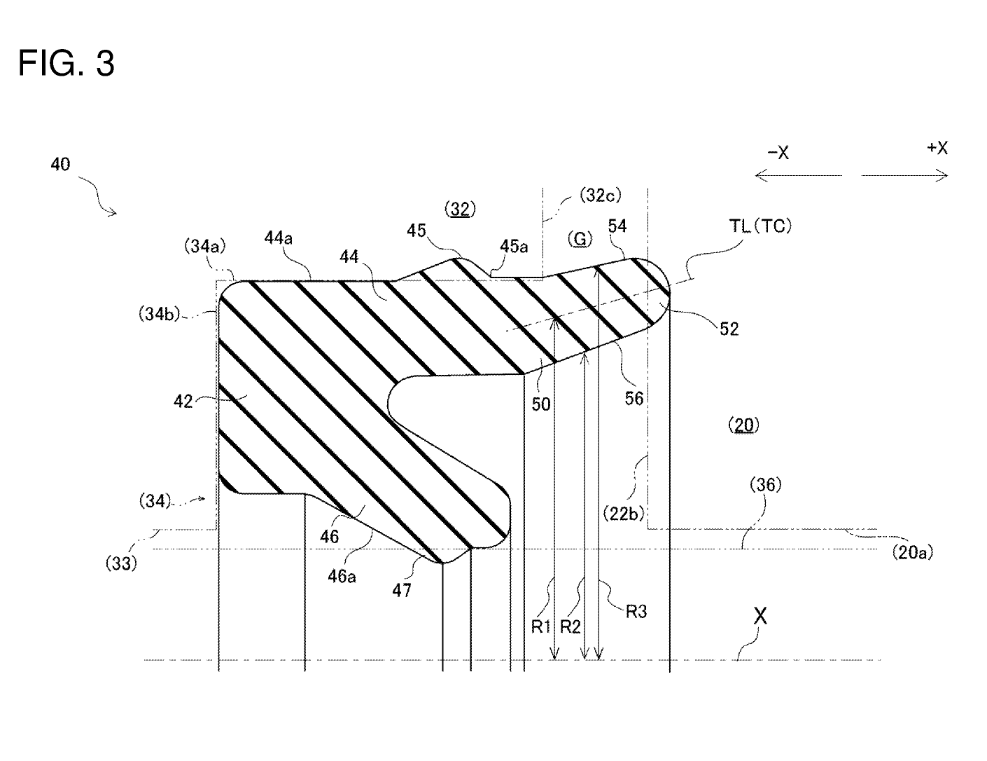

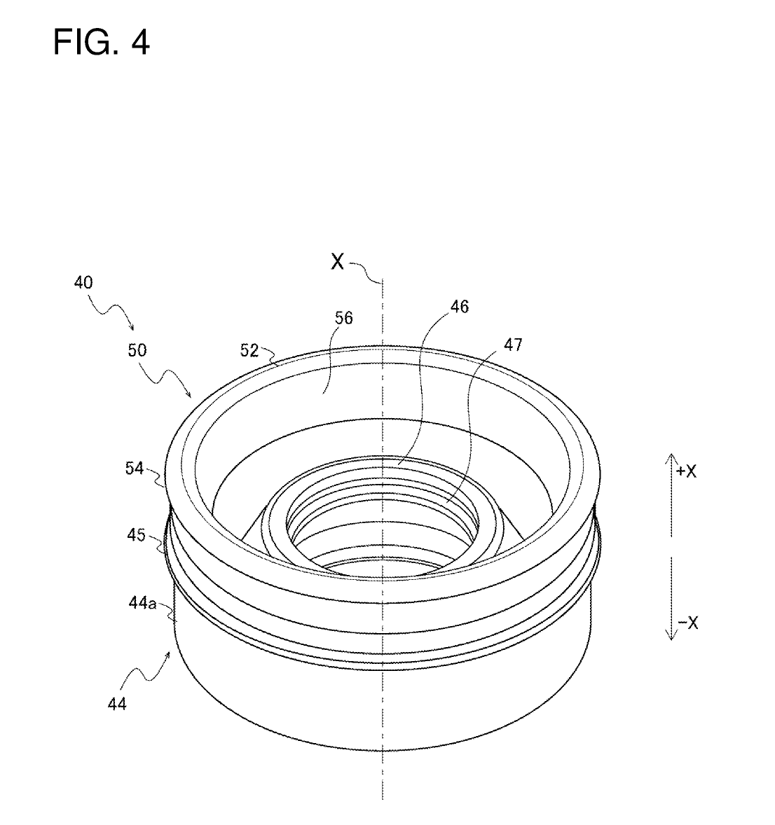

As shown in FIG. 3, and FIG. 4 the sealing member 40 is hollow and cylindrical, and extends along the axis X. The sealing member 40 is annular with the axis X as a centerline. The sealing member 40 may be coaxial with the through-hole 20a and the hole 33. The sealing member 40 is formed from an elastomer. The elastomer for the sealing member 40 may be one of nitrile rubber (NBR), hydrogenated nitrile rubber (H-NBR), acrylic rubber (ACM), fluorine rubber (FKM), silicone rubber, or styrene butadiene rubber (SBR). The sealing member 40 includes the first annular portion 44, a second annular portion 46, and the connecting portion 42. The first annular portion 44, the second annular portion 46, and the connecting portion 42 are integral with one another.

As shown in FIG. 2, and FIG. 3 the first annular portion 44 is in contact with the wall 34a of the holder 32. The first annular portion 44 has a cylindrical surface 44a. The cylindrical surface 44a faces radially outward and is in contact with the wall 34a. The first annular portion 44 includes a first sealing flange 45 and a protruding portion 50.

The first sealing flange 45 extends along the entire circumference of the cylindrical surface 44a and protrudes radially outward from the cylindrical surface 44a. The first sealing flange 45 is located away from the end of the sealing member 40 in contact with the step surface 34b of the holder 32 in the positive X-direction. When the sealing member 40 is located between the holder 32 and the pin 36, the first sealing flange 45 deforms along the wall 34a to seal a space between the first sealing flange 45 and the wall 34a of the holder 32.

The first sealing flange 45 includes a base 45a. The base 45a is a basal end of the first sealing flange 45 in the positive X-direction with respect to a top portion of the first sealing flange 45. The base 45a is located farther than the end face 32c of the holder 32 in the negative X-direction. In other words, the base 45a is located farther than the space G in the negative X-direction. The portion of the first annular portion 44 located in the negative X-direction from the base 45a seals a space between the first annular portion 44 and the wall 34a more tightly than the portion of the first annular portion 44 located in the positive X-direction from the base 45a. The first annular portion 44 and the protruding portion 50 in one or more embodiments of the present disclosure are distinguished from each other at the base 45a serving as a boundary.

The protruding portion 50 will be described in detail later.

As shown in FIGS. 2 and 3, the second annular portion 46 is located radially inward from the first annular portion 44. The second annular portion 46 is in contact with the cylindrical surface 36a of the pin 36 in a slidable manner. The second annular portion 46 has a slope 46a. The slope 46a is inclined in the X-direction and faces radially inward. The slope 46a faces the cylindrical surface 36a. The distance between the slope 46a and the axis X decreases in the positive-X direction. The second annular portion 46 includes a second sealing flange 47.

The second sealing flange 47 extends along the entire circumference of the slope 46a and protrudes radially inward from the slope 46a. The second sealing flange 47 is located away from the end of the sealing member 40, which is in contact with the step surface 34b of the holder 32 in the positive X-direction. When the sealing member 40 is located between the holder 32 and the pin 36, the second sealing flange 47 elastically deforms along the pin 36 to seal a space between the second sealing flange 47 and the pin 36.

The connecting portion 42 connects the end of the first annular portion 44 in the negative X-direction and the end of the second annular portion 46 in the negative X-direction. When the sealing member 40 is located between the holder 32 and the pin 36, the connecting portion 42 is in contact with the step surface 34b of the step 34.

### Protruding Portion 50

The protruding portion 50 extends along the entire circumference of the first annular portion 44 and protrudes from the base 45a of the first annular portion 44 in the positive X-direction. In other words, the protruding portion 50 is located farther than the first annular portion 44 in the positive X-direction, with the base 45a serving as a boundary. When the sealing member 40 is located between the holder 32 and the pin 36, the protruding portion 50 may be in contact with the inner surface of the panel 20. The protruding portion 50 may have a smaller thickness than the first annular portion 44. The protruding portion 50 may have a thickness at the base 45a greater than the width of the space G in the X-direction. The protruding portion 50 has a distal end 52, an outer circumferential surface 54, and an inner circumferential surface 56.

The distal end 52 is the end of the protruding portion 50 in the positive X-direction. The distal end 52 is in contact with the bottom 22b of the receiver 22. When the holder 32 receiving the sealing member 40 is attached to the receiver 22 in the panel 20, the distal end 52 elastically deforms. In this state, the distal end 52 seals a space between the distal end 52 and the bottom 22b of the receiver 22. In this state, the distal end 52 may elastically deform toward the space G as shown in FIG. 2. In this state, the protruding portion 50 applies an elastic force to the first annular portion 44 in the negative X-direction as the distal end 52 elastically deforms.

As shown in FIG. 3, the outer circumferential surface 54 faces outward in the radial direction of the protruding portion 50. A distance R3 between the outer circumferential surface 54 and the axis X may increase in the positive X-direction. The outer circumferential surface 54 has a larger diameter than the wall 34a of the step 34 at the distal end 52. The outer circumferential surface 54 may have a larger diameter than the top portion of the first sealing flange 45 at the distal end 52. In other words, the outer circumferential surface 54 may have a larger maximum diameter than the first sealing flange 45. The outer circumferential surface 54 may be inclined with respect to the axis X at an angle of 5 to 30 degrees inclusive in a sectional view. More specifically, the outer circumferential surface 54 may be inclined with respect to the axis X at an angle of 5 to 15 degrees inclusive in a sectional view.

The inner circumferential surface 56 faces inward in the radial direction of the protruding portion 50. A distance R2 between the inner circumferential surface 56 and the axis X may increase in the positive X-direction. The distance R2 may increase in the positive X-direction at a higher rate than the distance R3. The rate at which the distance R2 or R3 increases in the positive X-direction is a dimensionless quantity indicating the radial distance R2 or R3 that increases in the positive X-direction per unit length. The inner circumferential surface 56 may be inclined with respect to the axis X at an angle of 5 to 30 degrees inclusive in a sectional view. More specifically, the inner circumferential surface 56 may be inclined with respect to the axis X at an angle of 15 to 25 degrees inclusive in a sectional view.

The protruding portion 50 may have a smaller thickness in the positive X-direction. The thickness of the protruding portion 50 is the distance between the outer circumferential surface 54 and the inner circumferential surface 56 in the radial direction. A middle point between the outer circumferential surface 54 and the inner circumferential surface 56 in the radial direction is referred to as a thickness center TC. The thickness center TC is an example of a center of thickness. An imaginary straight line connecting the thickness centers TC at positions in the X-direction is referred to as a thickness centerline TL. A distance R1 between the thickness centerline TL (in other words, the thickness center TC) and the axis X increases in the positive X-direction. The thickness centerline TL may be inclined with respect to the axis X at an angle of 5 to 30 degrees inclusive in a sectional view. More specifically, the thickness centerline TL may be inclined with respect to the axis X at an angle of 15 to 25 degrees inclusive in a sectional view.

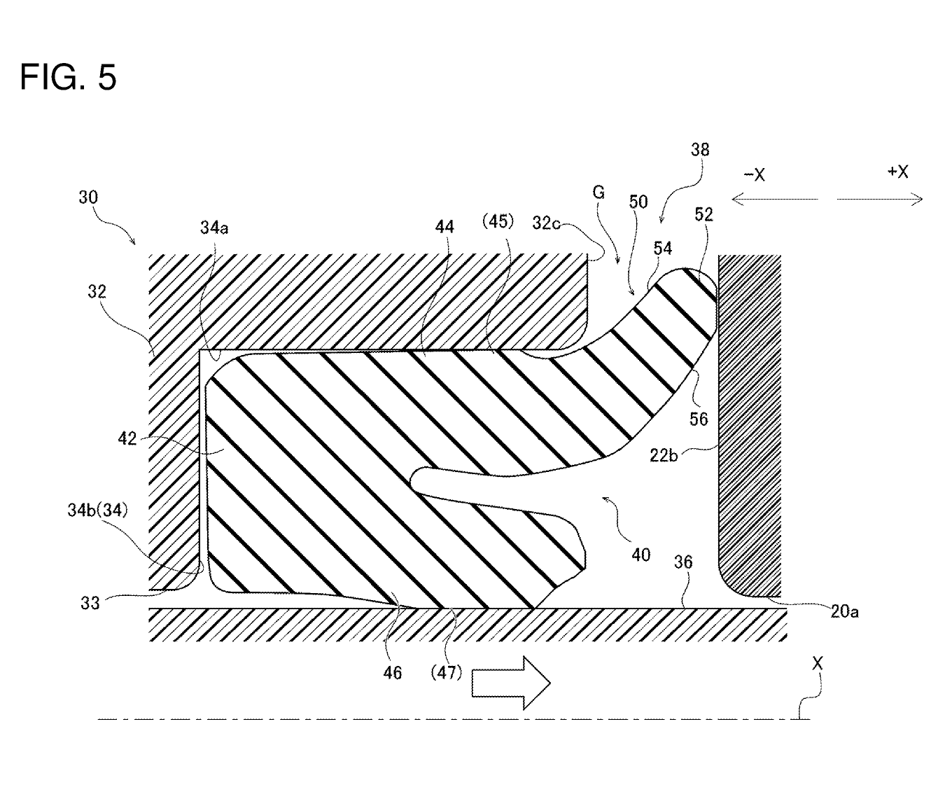

When the pin 36 moves in the positive X-direction in response to the plug 11 being attached to the inlet 12, the sealing member 40, which has the inner circumferential surface 56 in contact with the pin 36, moves in the positive X-direction in response to the movement of the pin 36. The sealing member 40 moves away from the step surface 34b while sliding relative to the moving pin 36. The sealing member 40 has the protruding portion 50, which is in contact with the bottom 22b of the receiver 22, elastically deforming toward the space G as shown in FIG. 5.

### ADVANTAGEOUS EFFECTS

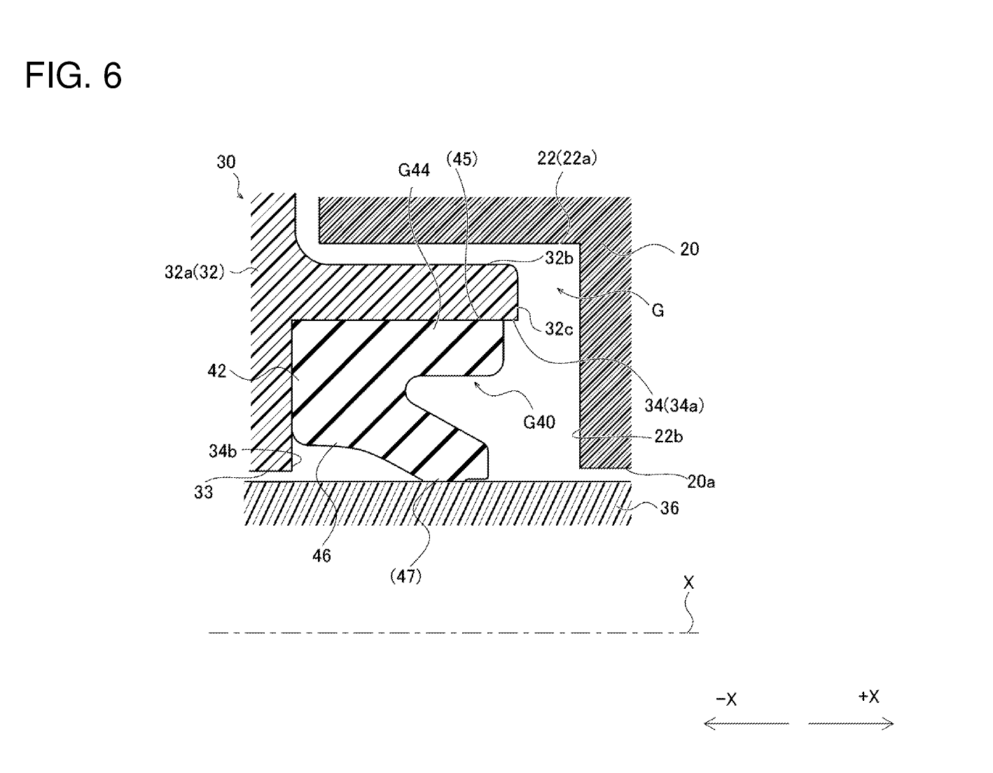

The advantageous effects of the sealing member 40 according to the embodiment will now be described. Sealing members G40 and H40 in comparative examples of the embodiment will be described with reference to FIGS. 6 to 9. Like reference numerals and names of the components of the sealing member 40 according to the embodiment are used for like components of the sealing members G40 and H40.

As shown in FIG. 6, the sealing member G40 in a first comparative example includes a first annular portion G44 in place of the first annular portion 44 in the sealing member 40. The first annular portion G44 does not include the protruding portion 50, unlike the first annular portion 44 in the sealing member 40.

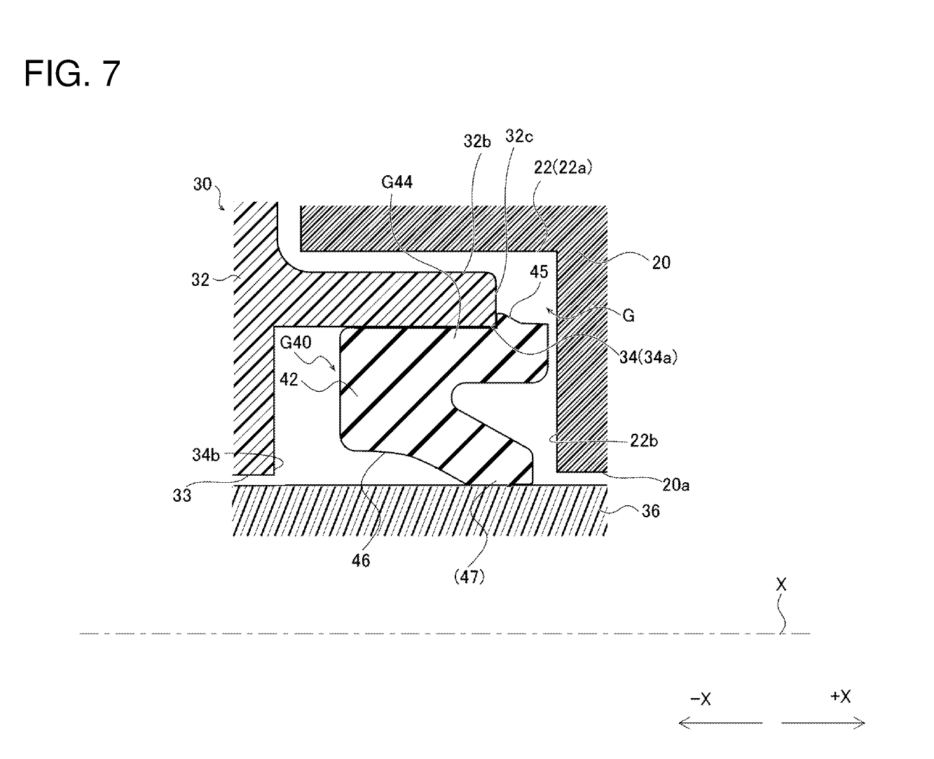

As shown in FIG. 6, when the pin 36 moves in the positive X-direction with the sealing member G40 in the first comparative example located between the holder 32 and the pin 36, the sealing member G40 moves in the positive X-direction in response to the movement of the pin 36. In this case, the sealing member G40 without the protruding portion 50 may move in the positive X-direction until the first sealing flange 45 slips out of the step 34 as shown in FIG. 7. In other words, with the sealing member G40 located between the holder 32 and the pin 36, the sealing member G40 may reduce tight sealing of a space between the sealing member G40 and the holder 32 as the pin 36 moves.

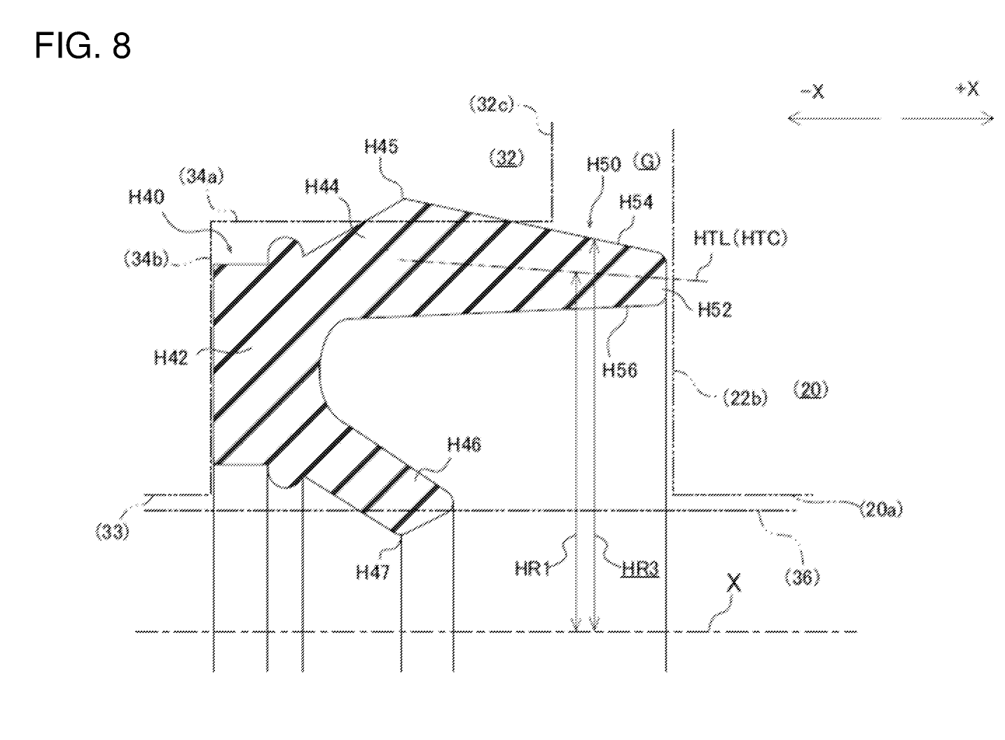

As shown in FIG. 8, the sealing member H40 in a second comparative example includes a first annular portion H44, a protruding portion H50, a distal end H52, and an outer circumferential surface H54 in place of the first annular portion 44, the protruding portion 50, a distal end 52 and the outer circumferential surface 54 included in the sealing member 40.

When the holder 32 receiving the sealing member H40 is attached to the receiver 22 in the panel 20, the distal end H52 of the protruding portion H50 comes in contact with the bottom 22b of the receiver 22.

A distance HR3 between the outer circumferential surface H54 and the axis X decreases in the positive X-direction. The outer circumferential surface H54 has, at the distal end H52, a smaller diameter than a top portion of the first sealing flange H45. A distance HR1 between a thickness centerline HTL (in other words, a thickness center HTC) of the protruding portion H50 and the axis X decreases in the positive X-direction.

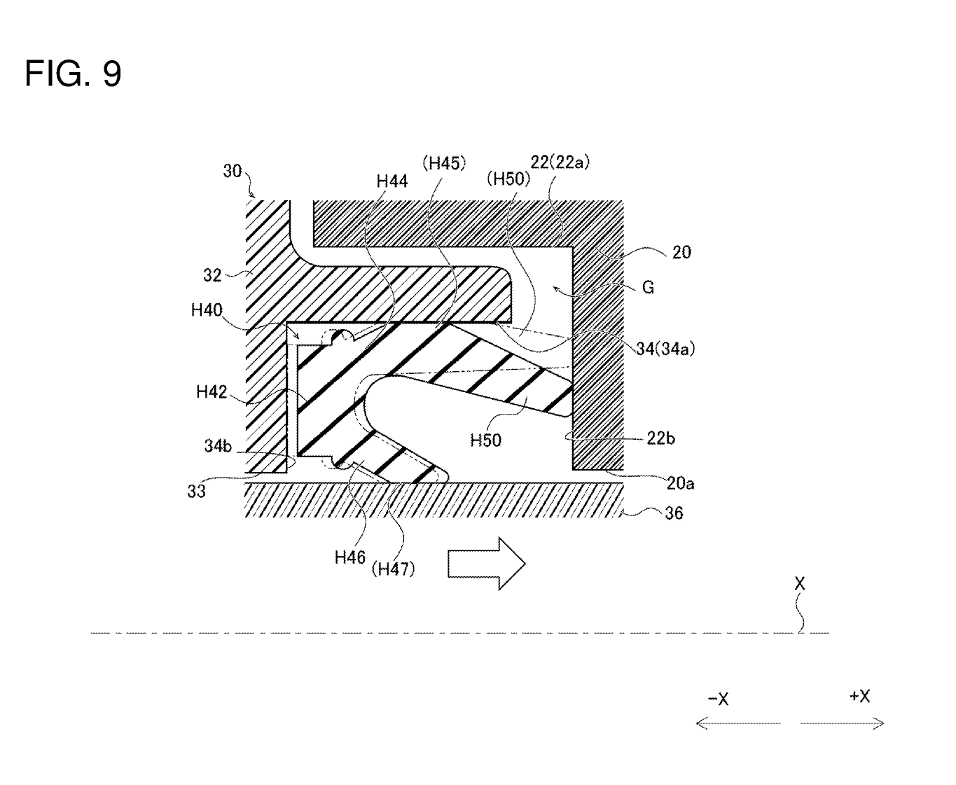

With the sealing member H40 in the second comparative example located between the holder 32 and the pin 36 and in contact with the bottom 22b of the receiver 22 as shown in FIG. 9, the protruding portion H50 receives an elastic force generated by contact with the bottom 22b. This elastic force is less likely to act in a direction in which the protruding portion H50 deforms toward the space G due to the shape of the protruding portion H50. In other words, the elastic force generated by contact between the protruding portion H50 and the bottom 22b is likely to act in a direction along the axis X. Thus, the elastic force generated by contact between the protruding portion H50 and the bottom 22b is likely to adversely affect the attachment of the holder 32 to the receiver 22. The elastic force generated by contact between the protruding portion H50 and the bottom 22b is likely to deform a portion of the panel 20 surrounding the through-hole 20a.

When the pin 36 moves in the positive X-direction, the sealing member H40 moves in the positive X-direction in response to the movement of the pin 36. The sealing member H40 moves away from the step surface 34b while sliding relative to the moving pin 36.

The elastic force generated by contact of the protruding portion H50 with the bottom 22b increases as the sealing member H40 moves. The increasing elastic force may deform the protruding portion H50 toward the axis X due to the shape of the protruding portion H50. When the protruding portion H50 deforms toward the axis X as the pin 36 moves, the protruding portion H50 may be caught by the moving pin 36.

When the protruding portion H50 deforms toward the axis X as the pin 36 moves, the protruding portion H50 may further deform toward the axis X easily as the pin 36 moves farther in the positive X-direction. When the protruding portion H50 continues to further deform toward the axis X, the sealing member H40 may have the first sealing flange 45 slipping out of the step 34. With the first sealing flange 45 slipping out of the step 34, the sealing member H40 less tightly seals a space between the sealing member H40 and the step 34 in the movable pin device 30. The first sealing flange 45 that has slipped out of the step 34 in response to the pin 36 moving in the positive X-direction cannot easily return to the step 34 when the pin 36 moves back in the negative X-direction later.

With the sealing member H40 located between the holder 32 and the pin 36 as described above, the sealing member H40 may have various failures resulting from the elastic force generated by contact between the protruding portion H50 with the above shape and the receiver 22.

In the sealing member 40 in the sealing structure 38 according to the embodiment, the distance R1 between the thickness centerline TL of the protruding portion 50 and the axis X increases in the positive X-direction. In other words, the protruding portion 50 in the sealing member 40 located between the holder 32 and the pin 36 extends toward the space G. Thus, when the protruding portion 50 in the sealing member 40 comes in contact with the bottom 22b of the receiver 22, the protruding portion 50 elastically deforms to enter the space G and extend radially outward. In this state, the elastic force generated by contact between the protruding portion 50 and the bottom 22b is less likely to act in the direction along the axis X. In other words, a component of the elastic force generated by contact between the protruding portion 50 and the bottom 22b in the axial direction is reduced compared with that in the sealing member H40. More specifically, the sealing member 40 in the sealing structure 38 can reduce the component of the elastic force generated by contact between the protruding portion 50 and the receiver 22 in the axial direction. Thus, the elastic force generated by contact between the protruding portion 50 and the bottom 22b is less likely to adversely affect the attachment of the holder 32 to the receiver 22. The elastic force generated by contact between the protruding portion 50 and the bottom 22b is less likely to deform the portion of the panel 20 surrounding the through-hole 20a.

The first annular portion 44 further includes the protruding portion 50. The second annular portion 46 is in contact with the pin 36 in a slidable manner. Thus, when the pin 36 moves in the positive X-direction, the sealing member 40 receives, from the pin 36, an external force that moves the sealing member 40 in the positive X-direction. The protruding portion 50 is in contact with the bottom 22b of the panel 20, thus reducing the likelihood of the first sealing flange 45 slipping out of the step 34 in the movable pin device 30. In other words, the sealing member 40 in the sealing structure 38 includes the protruding portion 50, thus further reducing the likelihood of the first sealing flange 45 slipping out of the step 34 in the movable pin device 30 in response to the pin 36 moving in the positive X-direction. This reduces the likelihood that the sealing member 40 less tightly seals a space between the sealing member 40 and the step 34 as the pin 36 moves in the positive X-direction.

The sealing member H40 in the second comparative example includes the protruding portion H50, thus reducing the likelihood of the first sealing flange 45slipping out of the step 34 in the movable pin device 30 in response to the pin 36 moving in the positive X-direction.

When the sealing member 40 moves in the positive X-direction in response to the pin 36 moving in the positive X-direction, the sealing member 40 has the protruding portion 50, which has elastically deformed to enter the space G and extend radially outward, elastically deforming further to extend radially more outward into the space G. The sealing member 40 is less likely to have the protruding portion 50 caught by the pin 36 moving in the positive X-direction. In other words, the sealing member 40 further reduces the likelihood of the first sealing flange 45 slipping out in response to the pin 36 moving in the positive X-direction.

When the distal end 52 comes in contact with the bottom 22b of the receiver 22 and elastically deforms, the protruding portion 50 applies an elastic force to the first annular portion 44 in the negative X-direction in response to the deformation. This reduces the likelihood that the sealing member 40 moves in the positive X-direction in response to the pin 36 moving in the positive X-direction.

The distance R2 between the inner circumferential surface 56 and the axis X increases in the positive X-direction. The sealing member 40 thus has the protruding portion 50 elastically deforming easily to enter the space G and extend radially outward in response to contact with the bottom 22b of the receiver 22.

The distance R3 between the outer circumferential surface 54 and the axis X increases in the positive X-direction. The sealing member 40 thus has the protruding portion 50 elastically deforming further easily to extend radially more outward into the space G in response to contact with the bottom 22b of the receiver 22.

The distance R2 increases in the positive X-direction at a higher rate than the distance R3. The sealing member 40 thus has the protruding portion 50 elastically deforming still further easily to extend radially still more outward into the space G in response to contact with the bottom 22b of the receiver 22.

The outer circumferential surface 54 has a larger diameter than the top portion of the first sealing flange 45 at the distal end 52. The sealing member 40 is thus less likely to reduce tight sealing of the first sealing flange 45 when the sealing member 40 comes in contact with the bottom 22b of the receiver 22 and elastically deforms. In other words, the sealing member 40 can maintain tight sealing of the first sealing flange 45 when the sealing member 40 comes in contact with the bottom 22b of the receiver 22 and elastically deforms.

The protruding portion 50 has the distal end 52 elastically deforming in response to contact with the bottom 22b of the receiver 22 to seal a space between the protruding portion 50 and the bottom 22b. The sealing member 40 can thus reduce the entry of foreign objects from radially outside to radially inside through the protruding portion 50.

The base 45a is located farther than the space G in the negative X-direction. The sealing structure 38 can thus maintain tight sealing of a space between the pin 36 and the step 34 when the sealing member 40 moves in response to the movement of the pin 36 in the positive X-direction.

Although embodiments of the present invention have been described by way of example, the present invention is not limited to the embodiments described above, and may be modified, changed, or varied in various manners within the scope of technical idea of the present invention.

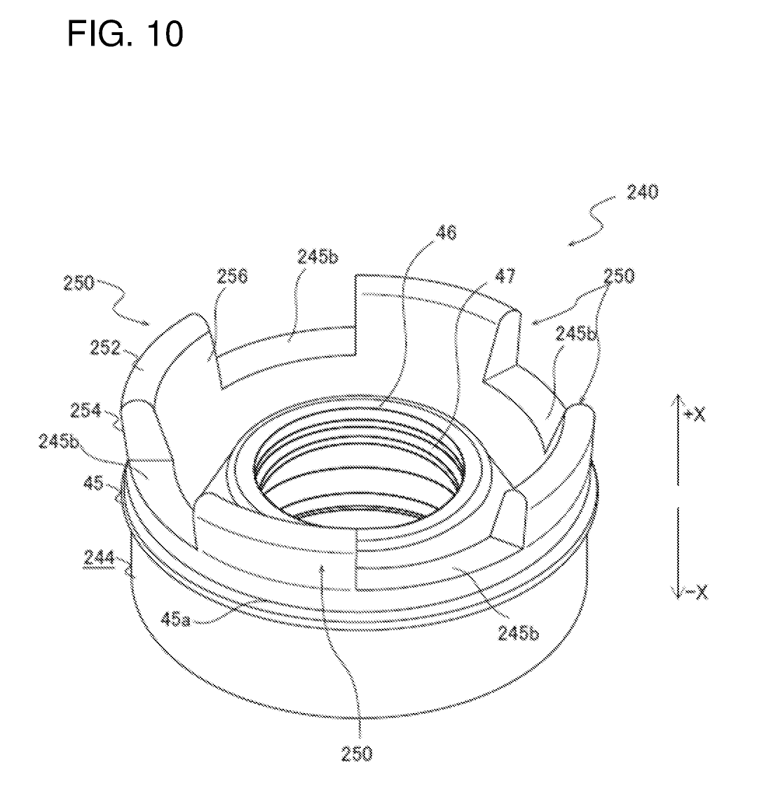

In the above embodiment, the protruding portion 50 extends along the entire circumference of the first annular portion 44 and protrudes from the base 45a of the first annular portion 44 in the positive X-direction. However, the protruding portion in one or more embodiments of the present disclosure may not extend along the entire circumference of the first annular portion and may not protrude from the base 45a of the first annular portion in the positive X-direction. The protruding portion in one or more embodiments of the present disclosure may be in the form of protruding portions 250 included in a sealing member 240 shown in FIG. 10. The sealing member 240 and the protruding portions 250 will be described in detail below.

The holder 32, the movable unit 35, and the sealing member 240 form a sealing structure 238 (not shown) in the movable pin device 30.

The sealing member 240 includes a first annular portion 244 in place of the first annular portion 44 in the sealing member 40. The first annular portion 244 includes multiple protruding portions 250 in place of the protruding portion 50. The first annular portion 244 further has lip end faces 245b.

As shown in FIG. 10, the multiple protruding portions 250 are spaced from one another in the circumferential direction about the axis X, and arranged farther than the first annular portion 244 in the positive X-direction, with the base 45a serving as a boundary. The protruding portions 250 in the sealing member 240 do not seal a space between the protruding portions 250 and the receiver 22 in response to contact with the bottom 22b of the receiver 22.

Each lip end face 245b is located between two protruding portions 250 adjacent to each other in the circumferential direction. The lip end faces 245b are arranged between the base 45a of the first sealing flange 45 and distal ends 252 of the protruding portions 250 in the X-direction. The lip end faces 245b face in the positive X-direction.

In the example shown in FIG. 10, the sealing member 240 includes four protruding portions 250 and four lip end faces 245.

The multiple protruding portions 250 are spaced from one another in the circumferential direction, and thus elastically deform radially outward more easily than the protruding portion 50. The protruding portions 250 in the sealing member 240 thus receive a smaller elastic force generated by contact with the receiver 22 than the protruding portion 50 in the sealing member 40. The sealing member 240 can thus reduce a load applied to the panel 20 under the elastic force generated by contact between the protruding portions 250 and the receiver 22. The sealing member 240 can also further reduce the likelihood that the elastic force generated by contact between the protruding portions 250 and the bottom 22b adversely affects the attachment of the holder 32 to the receiver 22.

The sealing member 240 in the sealing structure 238 produces the same effects as the sealing member 40 in the sealing structure 38 except that the sealing member 240 does not seal a space between the sealing member 240 and the receiver 22.

The sealing member 240 includes four protruding portions 250. However, for the sealing member according to one or more embodiments of the present disclosure that includes multiple protruding portions spaced from one another in the circumferential direction, the sealing member may include two or three protruding portions or five or more protruding portions.

### REFERENCE SIGNS LIST

10 lock pin structure

11 plug

11a latch

12 inlet

12a latch

20 panel (example of first structure)

20a through-hole

22 receiver

22b bottom

30 movable pin device (example of second structure)

32 holder

33 hole

34 step

34a wall

34b step surface

35 movable unit

36 pin (example of penetrator)

38 sealing structure

40 sealing member

42 connecting portion

44 first annular portion

45 first sealing flange

45a base

46 second annular portion

50 protruding portion

52 distal end

54 outer circumferential surface

56 inner circumferential surface

240 sealing member

250 protruding portion

G space

TC thickness center

TL thickness centerline

R1 radial distance between thickness center and axis (first distance)

R2 radial distance between inner circumferential surface and axis (second distance)

R3 radial distance between outer circumferential surface and axis (third distance)

X axis

What is claimed is:

1. A sealing member for sealing a space between a penetrator and a second structure, the second structure being aligned with a first structure on an axis extending in an axial direction with a space between the second structure and the first structure, the penetrator being through the first structure and the second structure along the axis and being reciprocable in the axial direction, the sealing member comprising:
a first annular portion to come in contact with the second structure, the first annular portion including a first sealing flange to seal a space between the first sealing flange and the second structure;
a second annular portion to come in contact with the penetrator in a slidable manner; and
a connecting portion connecting ends of the first annular portion and the second annular portion, the ends being located in a direction opposite to a first direction from the second structure to the first structure parallel to the axial direction,
wherein the first annular portion further includes a protruding portion located farther than the first sealing flange in the first direction to come in contact with the first structure.

2. The sealing member according to claim 1, wherein
the protruding portion has a first distance between a center of thickness of the protruding portion and the axis, and the first distance increases in the first direction.

3. The sealing member according to claim 1, wherein
the protruding portion elastically deforms in response to contact with the first structure to apply an elastic force to the first annular portion in the direction opposite to the first direction.

4. The sealing member according to claim 1, wherein
the protruding portion has an inner circumferential surface having a second distance between the inner circumferential surface and the axis, and the second distance increases in the first direction.

5. The sealing member according to claim 1, wherein
the protruding portion has an outer circumferential surface having a third distance between the outer circumferential surface and the axis, and the third distance increases in the first direction.

6. The sealing member according to claim 5, wherein
the second distance increases in the first direction at a higher rate than the third distance.

7. The sealing member according to claim 5, wherein
the outer circumferential surface has a larger diameter than the first sealing flange at a distal end of the protruding portion.

8. The sealing member according to claim 1, wherein
the protruding portion seals a space between the protruding portion and the first structure.

9. The sealing member according to claim 1, wherein
the first annular portion includes a plurality of the protruding portions spaced from one another in a circumferential direction.

10. A sealing structure, comprising:
a second structure to be aligned with a first structure on an axis extending in an axial direction with a space between the second structure and the first structure;
a penetrator to extend through the first structure and the second structure along the axis; and
the sealing member according to claim 1 located between the second structure and the penetrator,
wherein the protruding portion extends toward the space.

11. The sealing structure according to claim 10, wherein
the first sealing flange protrudes radially outward from the first annular portion,
the first sealing flange includes, with respect to a top portion of the first sealing flange, a base being a basal end of the first sealing flange in the first direction, and
the base is away from the space in the direction opposite to the first direction.

12. A sealing member, comprising:
a first annular portion located about an axis, the first annular portion including, at an end of the first annular portion in a first direction along the axis, a first sealing flange protruding radially outward;
a second annular portion spaced and radially inward from the first annular portion;
a connecting portion connecting ends of the first annular portion and the second annular portion, the ends being located in a direction opposite to the first direction; and
a protruding portion located farther than the first sealing flange in the first direction, the protruding portion having a first distance between a center of thickness of the protruding portion and the axis, the first distance increasing in the first direction.

13. The sealing member according to claim 2, wherein
the protruding portion elastically deforms in response to contact with the first structure to apply an elastic force to the first annular portion in the direction opposite to the first direction.

14. The sealing member according to claim 2, wherein
the protruding portion has an inner circumferential surface having a second distance between the inner circumferential surface and the axis, and the second distance increases in the first direction.

15. The sealing member according to claim 3, wherein
the protruding portion has an inner circumferential surface having a second distance between the inner circumferential surface and the axis, and the second distance increases in the first direction.

16. The sealing member according to claim 2, wherein
the protruding portion has an outer circumferential surface having a third distance between the outer circumferential surface and the axis, and the third distance increases in the first direction.

17. The sealing member according to claim 3, wherein
the protruding portion has an outer circumferential surface having a third distance between the outer circumferential surface and the axis, and the third distance increases in the first direction.

18. The sealing member according to claim 4, wherein
the protruding portion has an outer circumferential surface having a third distance between the outer circumferential surface and the axis, and the third distance increases in the first direction.

19. The sealing member according to claim 6, wherein
the outer circumferential surface has a larger diameter than the first sealing flange at a distal end of the protruding portion.

20. The sealing member according to claim 2, wherein
the protruding portion seals a space between the protruding portion and the first structure.
